(19) United States
(12) Patent Application Publication
(10) Pub. No.: US 2003/0097293 A1
(43) Pub. Date: May 22, 2003

(54) Method for evaluating motivations

(76) Inventor: Constance A. Williams, Hartford, CT (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/988,567

(22) Filed: Nov. 20, 2001

(51) Int. Cl. G06F 17/60

(52) U.S. Cl. 705/10

(57) ABSTRACT

A multi-step method for determining the marketplace motivation of customers to purchase an item such as a product, brand or service including eliciting from a group of customers analogies in some form associated with the item but not directed specifically to motivation, creating a database of the responses, evaluating the answers to derive meanings therefrom that relate to the item, using creative thinking techniques including word association, mind maps, analogies and metaphors, further comparing various derived meanings in light of directly relevant inquiries as to customer needs and wants.

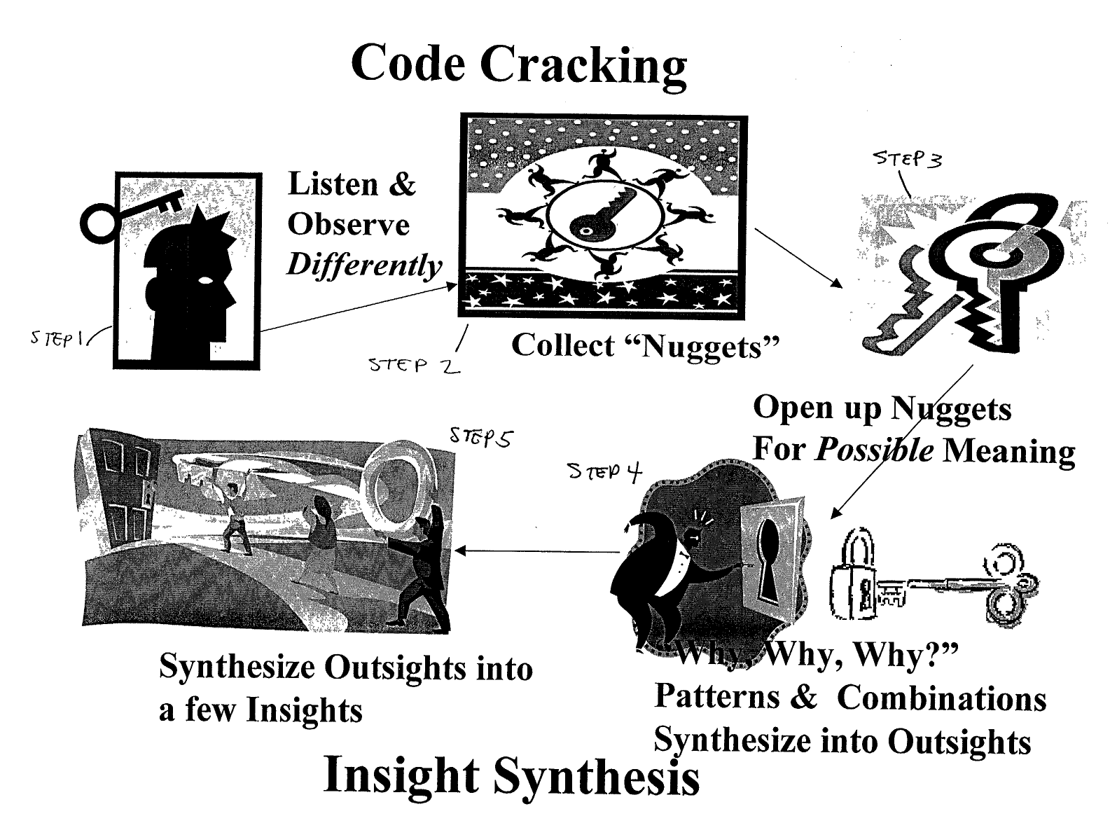

### SUBJECT MATTER OF THE INVENTION

The subject matter of the present invention relates to a method for determining the marketplace motivation of customers.

### BACKGROUND OF INVENTION

Traditionally, product and brand marketing has relied on a variety of techniques that heavily depend upon consumer information acquired through traditional surveys, quantitative research and other means to achieve appropriate marketing programs and brand promotion. Most systems for achieving marketing programs rely upon acquisition of data about a customer's behavior and specifically their usage and attitudes in the marketplace. Although a great deal of data and information may be acquired, and although many analysts assume their conclusions based on such data and provide insight into the reasons customers act as they do, they are, in fact, actually providing nothing more than summaries about the data they have gathered in their investigations of the product or brand. In substance, therefore, many marketing programs are unable to truly differentiate themselves one from the other because they are simply re-hashing essentially the same data, and, in the end provide nothing more than summaries of data.

These efforts overlook and fail to use processes that makes effective use of creative thought and non-traditional disciplines in which quantitative data is merely one of the tools used in reaching an understanding about consumer motivation. The failure of prior marketing evaluation systems to more closely analyze the consumer psyche, their language, and semiotics—the symbols and metaphors used by individuals and cultures to create meaning—is a deficiency that has limited a more comprehensive understanding of consumer marketplace behavior.

The present invention is designed to create true insight about marketplace motivation of consumers by exploring consumer language and semiotics, utilizing creative discovery techniques including using different skills in listening and discovering hidden meanings in the language, symbols and actions of consumers. These discoveries are synthesized into new patterns and combinations to develop an understanding of what truly motivates consumers to act in certain specific ways. Seeking deep insights into customer motivations requires sensitivity and reaction to the beliefs, wants and needs which individuals (consumers, customers) have in a marketplace setting and as human beings. The method seeks to extend beyond an understanding of how the consumer behaves, and determine the reasons why consumers behave as they do. By achieving such deep insight, many marketing implications for a particular brand, product, or company may be uncovered. Discovery of a few, profound insights of the how and why consumers behave as they do becomes a focus of the method herein described. Such few, profound insights are more valuable than large quantities of quantitative data and statistics.

In the present invention, the method contemplates determining the marketplace motivations of consumers by evaluating their language and semiotics in which a representative group of consumers of an item such as a soft drink or an insurance policy or other service or product is selected for evaluation. Information is elicited from the group by using a variety of projective and tangential methods in which information is indirectly associated with the item to be evaluated. It is here that images are elicited from the consumers through facilitated creative processes, both individually and in small groups, about their needs relative to brands, products and categories. The information solicited takes the form of visual images, metaphors, and analogies, and the most provocative of these are extracted and characterized hereafter as “nuggets.” Nuggets are then explored for deeper meaning through creative thinking exercises including word association, metaphor, analogy and absurd and irrelevant connections. The evaluation is intended to derive meanings of the information obtained and to collect the derived meanings into an expanded database called “geodes.” This information is recorded and collected into a database and then the connections are analyzed by looking for new combinations, comparisons with other data and encoded messages that relate to the subject matter of evaluation and which begin to hypothesize the reasons consumers behave as they do.

My process is based on what is called “three process theory” by cognitive psychologists who study insight (mostly in non-business aspects). “Insight” is a sudden recognition of an answer or solution to a matter. I consider insight different from simple problem solving. In this instance, one or more of the components of the three process theory may be used for purposes of achieving this insight. Three process theory consists of Selective Combination, Selective Comparison and Selective Encoding. Selective Combination is essentially looking at patterns of data and recombining the data in fresh ways to see a new, breakthrough aspect. Selective Comparison is seeing new aspects by comparing the data to other things and frequently relying on analogies and metaphors to see relationships. Selective Encoding takes data and combines it with data that initially seemed irrelevant and conversely removed from consideration of data that initially seemed relevant. The three process theory is described in a number of publications including The Nature of Insight, edited by Robert A. Sternberg and Janet E. Davidson and it was published in 1995, Massachusetts Institute of Technology. Though these publications have extensively studied and considered the three process theory, these studies have all been academic in nature and have never utilized this theory for commercial purposes. For the most part, this theory has been confined to a passive application to determine how people solve issues. The teachings of these learning theorists in short have been confined to observations and have never been developed into a complete process utilizing study groups keyed to particular brands, products, or other business issues.

Segments of this further database are separately analyzed and compared to synthesize a pattern or theme relative to the item. The derived meanings, called “outsights,” are then separately further synthesized, relative to the item which is the subject matter of the study, by studying the outsights and looking for common foundations of consumer motivation, further synthesizing the outsights into a few, driving insights about why the consumer acts as he/she does. These insights or motivations of consumers relative to the item are inferred from the separately derived meanings testing the insights by using the inquisitive language “consumers want . . . ,” “consumers believe . . . ,” or “consumers need . . . ” By asking this type of question, we are getting beyond inquiries looking for simple information and getting at the true values of the consumers. In short, I look for the common or unifying elements. I look for the shared “genealogy’ or foundation in the what seems to drive the way the consumer or customer behaves. The inquisition into wants, beliefs, or needs is an inquiry that may be initiated by the facilitator. However, in the process, the facilitator must require the group under study to articulate their position by using the phrases want, believe, or need as an expression of their motivation.

### DESCRIPTION OF DRAWING

The foregoing objects and advantages of the present invention may best be understood when considered in connection with the accompanying drawing in which the FIGURE schematically represents the process of the present invention.

### DETAILED DESCRIPTION OF INVENTION

The method which is the subject matter of this invention is directed primarily to determining the marketplace motivation of customers or consumers of a product, brand, or service. The material is applicable to a wide range of products, brands or services and to the analysis of a wide range of marketing issues relative thereto. Thus, the method may be applied to determine motivation of customers or consumers with respect to their interest in industrial products and brands and services. These products, brands, and services may be merchandised to a mass market as well as specialized or limited markets in substantially any price range. For this application, marketplace motivation is intended to mean the underlying needs and desires of customers or consumers of a particular brand, product, or service. In its broader aspect, market motivation may also apply to evaluations in a non-commercial setting in which the response of a group of individuals to a particular issue may be evaluated. Thus, the use of the terms, “product,” “brand,” and “service” are intended to have a broad application relative to a subject matter or item of common interest to a group of individuals.

In a preferred embodiment of this process, the evaluation starts with the selection of a representative group of individuals relative to the matter, such as the brand, product, or service, herein sometimes referred to as the “item.” This group may comprise a conventionally formed focus group or, depending upon the particular item involved in the study, may comprise selected individuals chosen through any other system in which the individuals forming the group possess some underlying or undiscovered motivations relative to the item in question. In a conventional and typical process, the individuals once selected into a group, meet with a person who will undertake the method or process herein described. After the group is formed, one or more discovery sessions with the group are conducted by the group leader or facilitator with the individuals in the group, wherein series of creative exercises relative to the product, brand, or service are presented to elicit answers. The discovery sessions with the group may, in some instances, be supplemented by interviews and observations of individuals. In such ancillary procedures, the observations do not necessarily involve interaction between the facilitator and the individual, but rather, observations of the individual's activities; whereas, the interview process does involve an interaction relative to the item in question. For example, if evaluating the behavior of kids in relation to soft drinks we might ask the participants to create analogies about a brand. The question might be asked: “If a soft drink brand, “Gulp,” was something else . . . a sport, a piece of clothing, a weather pattern, a car, what would it be? Another example might use the participants to create a visual collage using images clipped from magazines or drawn by them to represent what it would be like to be on the soft drink, Gulp, brand team if it competed in a sport. We might ask, for example, “What colors would represent it? What do the team members represent? What kind of random word associations might we make with the brand name, Gulp, beyond its role as a name?”, etc. The questions presented to the group in the session, which may be similar to conventional focus group sessions, are intended to elicit visual images, metaphors, and analogies. At least some of these images, etc. should have some indirect relevance to the brand, product, or service. To obtain these answers, questions are asked that are provocative or raise provocative notions or involve interesting language. (Step 1) In particular, questions are asked that do not have direct relevance to the subject matter in question, but have some analogous or indirect connections to it. One might ask questions like, what color shoes are you wearing when you are hot and thirsty on a summer day, vs. after sports, vs. with a burger, vs. etc., so we can understand the various soft drink occasions. In short, the answers that might make reference to various colors are clues embedded in the colors that will enable the group to determine the attitude or feeling of consumers in respect to the soft drink or item in question. Then, one would try to open up the possible meanings behind the shoe color to develop ideas on different kinds of thirsts and beverage needs. The questions asked should solicit answers in the consumer's own language and should be recorded or heard without editorializing or paraphrasing the response. Thus, for example, if the subject matter being discussed relates to soft drinks, the following is an example of work involving a soft drink manufacturer and their investigation of children's motivations so the following questions may be posed: “My favorite book or television show is . . . ” “What does it mean if I say ‘This is just for kids?’ . . . ,” “If we were with Peter Pan and no one was telling us what to eat or drink, I would . . . ,” “If beverages were a holiday, or a sport, or a piece of clothing, they would be . . . ”

As suggested by the specific example set forth above, the questions posed to the group in the discovery and exploratory sessions using primary data in questions are intended to elicit responses, metaphors, provocative notions, and interesting language. The questions need not be directly rational questions related to the subject matter. Rather, they may be provocative questions that are more directly associated with the subject matter. Thus, for example, the group may be asked questions by analogy or questions by metaphor. Thus, the facilitator might ask in this example: “If this were a relative of yours, who would it be? If it were a building, what would it look like? Responses in the consumer's own words are solicited. Any information that is obtained regardless of relevance is to be noted and recorded in a suitable fashion. The process of capturing and recording these responses and reducing them to “nuggets” requires special attention to the answers in which the potential uniqueness of the answers are recognized by paying particular attention to the nature of the answer. This particular attention requires a special analysis of each answer by viewing it in a challenging fashion. For example, test the answer by applying observations to the answers. The facilitator, in concert with the individuals of the group, tries to pull out from all that was initially recorded provocative answers or the answers that were not understood. It is primarily in the surprising, and more unpredictable responses that the most valuable learning can happen. It is especially important to capture things that one just does not think matters, as seeming irrelevance can often be a key to a major breakthrough. These responses by the group may be characterized as “nuggets.” These “nuggets” are gathered in a database, Step 2, which may, in one embodiment, consist of nothing more than individual hand-written cards noting these nuggets. Alternate database gathering means, such as a computer database, may also be used.

The cards are then individually recorded into short phrases without changing the language. In short, the more relevant portions of a response are recorded.

The next step, Step 3, following the recording of individual nuggets on cards comprises deriving possible meanings of the nuggets. This evaluation of these nuggets is to guess at possible meaning relative to the subject matter of the study. In short, the expansion of the nugget is not for purposes of creating or obtaining new creative ideas, but rather to understand the meaning of the nugget both relative to the subject matter of the inquiry, and in a much broader sense, perhaps not consciously intended by the consumer, but nonetheless relevant in a more subconscious sense. In this further step 3, the meanings of the nuggets are initially determined or opened up using creative thinking techniques. Initially, conclusions are not reached, nor are the implications of these nuggets determined. In this step 3, the techniques used in analyzing the nuggets include the use of word associations, mind maps, interpretation of the nuggets using such techniques as analogies or metaphors, creating analogies or metaphors on key nuggets, using or drawing pictures or creating collages, role playing using the nugget, and posing paradoxes creating visual metaphors, using visual language and poetry. In short, a variety of examination methods may be used to derive further concepts from the nuggets. These are characterized as “geodes.” I have selected the term “geode” because, in substance, the process opens up the term to see what is inside of it.

The step 3 analysis may be better understood by the following example. Here we are seeking to have consumers share answers in wishful, imaginative, fanciful ways. For example, if they said “If Gulp was a color, it would be red” or “If Gulp was a sport, it would be rock climbing,” these are characterized as nuggets. In opening up the nuggets relating to soft drink “Gulp,” the group would be asked to guess the meaning of the nuggets. Thus in determining what red means . . . one would ask the group to guess or look at analogies such as what is red in other worlds—red is hot, red is fun, red is fast, red is Campbell's Soup, red is American flag, etc. With respect to the rock climbing nugget, the group might conclude it means danger, step by step, connected to others, vertical images, etc. After this has been done a number of times, all the guessed meanings are looked at to see new patterns, combinations, etc. to make outsights. In another example, if the world of dance is the subject matter or item, the group might be asked: “What is a Coke vs. a Mountain Dew. They might say Coke is a square dance and Mountain Dew is a rave dance.

The possible meanings reached in Step 3 are achieved through a series of creative exercises in which associations, metaphors and analogies of the subject matter of the geodes are considered.

Going to Step 4 is a major shift in direction. The first three steps are very much divergent thinking . . . while the next two are ones of synthesis and convergence. The first three of these are directed to determining possible meanings and associations. The next two are designed to converge these possible meanings and associations into new patterns, combinations and ways of looking at it. The next step, step 4, in this marketplace analysis is to create what is characterized as “outsights.” In this step, the individuals, preferably those who participated in the initial step, are divided into small groups. The number of groups may vary, as well as their makeup. Individuals in each group are given geodes which may have been recorded on the data cards. These geodes may be otherwise recorded and retained. As, for example, the geodes may be recorded in a computer database and appropriately divided among the individuals. The facilitator then directs these individuals to consider several cards containing geodes for purposes of synthesizing a pattern or theme from the geodes, themselves. Thus, if a group is sitting around a table, at least several of the persons in the group place one or more cards, each containing a geode previously collected and retained, on the table for further analysis. The object of this further analysis is to synthesize a pattern or theme from the several geodes being collectively examined. The individuals collectively examine the cards, looking for patterns from the various combinations by a comparison of them. Re-examination of geodes that may previously have been considered irrelevant may be focused into a potentially relevant idea. These concepts are directed to such thoughts as the consumer's wants or needs or beliefs as it may relate to the product, brand, or service under examination. In this step of synthesizing “geodes” into “outsights,” the thematic inquiries relate to why a combination of, pattern of, or individual geode are suggestive of some motivating characteristic relative to the product, brand or service. These outsights are then recorded on data cards or otherwise. In the previously described “Gulp” example, the following may be a set of outsights derived from geodes which had been previously developed:

Kids believe more is better than less

Kids believe anything is possible

Kids want the good stuff not to end

Kids need the thrill of the extreme

Kids believe that what is gross for adults is fun for them

Kids want the rules they love to break

Kids want to be older than they are

Many other outsights are possible. This derived information is characterized as “outsights” which are defined as a pre-insight connection. In short, they are close to insights into the customer's marketing motivations, but further review is generally advised.

In this further review, refining and understanding the meaning of various outsights is important. In the following step 5, groups that had been previously reviewing the cards are re-arranged to mix individuals from different groups into new separate groups. These newly formed groups are then provided with the previously prepared outsight cards and are requested to force fit the concepts set forth on a group of outsight cards together, and to further continue to synthesize the rationale or meaning of these terms. In short, after the outsights have been created and reduced to writing on a series of cards, the new groups individually review them for the purpose of determining what the linkages that ties them together may be. The search for these linkages is undertaken to seek the “AHA!” or insight about consumer motivation, why they behave in specific ways relevant to the specific product, brand, or service. The insight process in step 5 synthesizes the disparate pieces derived from a comparison and/or combination of a plurality of these outsights, using the visual element of the cards laid out before the group. The groups is directed to use pattern recognition techniques to see fresh relationships between outsights to discover casual behavior connections for the relevant brand or category being studied. In determining this new meaning, the outsights, individually and in combinations, are evaluated, applying to them such inquiries as what does the consumer want, believe, or need. The analysis should be directed to expanding the underlying reason why, in light of the various outsights, the consumers behave as they do. In the “Gulp” example set forth above, the defined outsights may be further refined into insights including the following example:

Kids need to practice being older

Kids need rules to establish boundaries and fantasies to extend boundaries

Kids want acknowledgement that things are different for them (vs. their parents experience as kids)

These final insights are used in deriving directly relevant understandings about customer motivation. For example, with these insights a brand may develop advertising that makes fun of parents' childhood experiences or stories or promotions that break some rules or treat kids as older than they really are, e.g., Burger King Big Kids meals with larger portions of soft drinks and food.

The derived information called insights are thus the final step, with this step directed to penetrating understanding of why customers or consumers behave as they do. The analysis at this step 5 inquiry deals with such questions as to why the consumer buys, why they select as they do, and what motivates their behavior using a synthesis of outsights to achieve a few insights. The team then uses these to invent a series of “therefores” relating to new products, brand marketing, advertising or promotion.

The preceding is a description of a preferred embodiment. Also contemplated is a proceeding in which one or more of the five steps may be modified. For example, instead of forming a group and facilitator as set forth in connection with Step 1, and in place of a focus group, observations/interviews or other discovery sessions, a facilitator may use secondary or tertiary sources.

Thus, many images that represent consumer language or images can be used. But the most valuable sources are those closest to the consumer and the sources farther away but still calling up images and colorful language and semiotics are less but still somewhat valuable—e.g. an article about some cultural phenomenon or advertising campaign, or commercial advertising. Thus, the most desirable sources are the primary sources, that contain the actual words, phrases, visual images and associations that are elicited through consumer discovery groups, interviews and direct observations. For instance, competitive advertising can be examined for the symbols and words used, or alternately published articles about products, consumers, trends, etc. Even quantitative research such as segmentation or attitude and usage tracking sources are valuable when examining paradoxical or complex data, and when combined with primary sources. So, quantitative studies might say that women are the primary purchasers of a soft drink but usage attributes show that masculine images are most associated with that brand. We might use that seeming paradox and the details within to further explore gender relationships for a category by using creative exercises and combining it with other data.

Having now describe my invention, I claim:

1. A method for determining marketplace motivation of consumers of a product, brand or service comprising selecting a group representative of consumers of the product, brand or service, conducting one or more discovery sessions with the group wherein a series of questions relative to the product or service are presented to the consumers in the sample to elicit answers, said questions including those intended to elicit answers selected from a group comprising visual images, metaphors and analogies having no direct relevance to the product or service, collecting said answers into a database, evaluating thereafter each answer relative to the product, brand or service to derive possible meanings of each answer, and collecting the possible meanings into a further database, thereafter forming separate subgroups of the group for separately analyzing the derived meanings to synthesize a plurality of derived meanings into a pattern or theme relative to the product or service, thereafter creating a set of subgroups from the original group, with said new set of subgroups further synthesizing the derived meanings into meanings relative to marketplace motivations of the consumers of the product or service.

2. A method of determining marketplace motivations of consumers by evaluating their language and semiotics comprising selecting a representative group of consumers of an item to be evaluated, obtain from the group information indirectly associated with the item selected from a group comprising visual images, metaphors and analogies, collecting the information into a database, analyzing the information in respect to its relevance to the item, to derive possible meanings of the information, and collecting said derived meanings in a further database, separately analyzing segments of said further database to synthesize a pattern or theme relative to the item, separately synthesizing further derived meanings relative to the item using separate groups of derived meanings of said further database, and thereafter determining from said separately derived meanings motivations of the consumers relative to the item.

3. A method of determining motivation of consumer interest in an item by evaluating their language and/or semiotics comprising using three process theory techniques to solicit nuggets in the form of visual images and metaphors, then evaluating the derived nuggets using word association, metaphors, analogies and/or absurd and irrelevant connections to derive one or more geodes,
and analyzing the geodes as they relate to the item of interest using the comparisons with other data combinations of geodes and encoded messages to hypothesize reasons consumers may be motivated as they appear to be relative to the item in question.

4. A method as set forth in claim 1 wherein the consumers are evaluated using a focus group and facilitator.

5. A method as set forth in claim 4 wherein the solicitations of nuggets involves questions that are selected from a group of questions that are provocative, raise provocative notions, do not have direct relevance to the item of interest, and have analogous and indirect relevance to the item of interest.

6. A method as set forth in claim 5 wherein answers to questions are recorded without editorializing or paraphrasing the response.

7. A method as set forth in claim 5 wherein the evaluation of the nuggets further involves steps selected from the group comprising drawing pictures, creating collages, role playing, and posing paradoxes.

8. A method as set forth in claim 1 wherein analyzing the geodes involves synthesizing and converging existing geodes into outsights of new patterns and combinations of terms having relevance to the item in question.

9. A method as set forth in claim 8 wherein the outsights are further synthesized to achieve a rational or meaning more directly relating the previously defined outsight into an insight directly relevant to consumer interest in the item.
